(19) United States
(12) Patent Application Publication
(10) Pub. No.: US 2007/0047490 A1
(43) Pub. Date: Mar. 1, 2007

(54) Fast handoff in wireless local area network

(75) Inventors: Henry Haverinen, Jyvaskyla (FI); Mikko Jaakkola, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/214,120

(22) Filed: Aug. 29, 2005

(51) Int. Cl. H04Q 7/00

(52) U.S. Cl. 370/331

(57) ABSTRACT

Handoff of a communication session in a wireless network is presented in a wireless network interface including a terminal device having a first address (ADD1) and a second address (ADD2) in which an ongoing communication session between the terminal device and an associated first access point (AP1) in the wireless network uses the first address (ADD1) and upon detecting the need for handover of the terminal device to a second access point (AP2) in the wireless network establishes a communication session between the terminal device and an associated second access point (AP2) using the second address (ADD2). The invention includes hardware component and software application implementation.

### TECHNICAL FIELD

The present invention relates generally to wireless local area network communication and deals more particularly with voice communication on such networks. More specifically, the present invention deals with handoff of voice communication over wireless local area networks, specifically IEEE 802.11 networks.

### BACKGROUND OF THE INVENTION

Voice over Internet Protocol (VoIP) is the process of transmitting telephone calls over IP data networks. The delivery of voice information using the Internet Protocol (IP) typically involves transmission of small blocks of data utilizing packet switching. In packet switching, a connection is only opened for the packet transmission duration time to effectively minimize the connection that is maintained between systems to avoid loading down the network and thus multiple calls may share the same space. Voice in general, unlike data on IP networks does not tolerate glitches or breaks in communication and is delay sensitive. Consequently, latency which is defined as the time it takes for a packet to cross a network connection from an origination to a destination is an extremely important consideration in VoIP particularly in wireless local area networks (WLAN).

Wireless local area networks (WLAN), specifically IEEE 802.11 networks which are well known and understood by those skilled in the art are gaining in popularity and usage and are increasingly being used for voice communication using the Internet Protocol (IP). In general, a terminal device associates with an access point in its serving coverage area and which access point forwards or transmits data information having the terminal device destination IP address. As the terminal device moves within the service coverage area it may come into the range of a different access point from which the terminal device would now receive data information having the terminal device destination IP address. In moving from one access point to another access point, the call connection must be handed off from the one access point to the other access point using an appropriate handoff sequence for the involved access points, and often for the particular terminal device used.

One problem related to the use of wireless local access networks for voice is the latency of the handoff in communication between access points which results in breaks or interruptions in communication and poor quality of service particularly during the handoff interval. Accordingly, there is a need to maintain uninterrupted voice communication and quality of service during handoffs in wireless local access networks, particularly IEEE 802.11 networks.

Currently, standardization efforts are being pursued for fast handoffs in IEEE 802.11 networks in an attempt to minimize problems associated with latency; however, recent security enhancements using for example, wrong password attempts (WPA) and IEEE 802.11(i) have increased the latency encountered in associating with an access point. Various approaches and techniques have been proposed for the IEEE standardization including vendor specific fast handoff solutions which solutions require support in both the access point and the terminal device.

One drawback associated with prior art vendor specific fast handoff solutions is that not all vendors have access point products and accordingly the vendor specific approach is not suitable and satisfactory for those vendors not having access point products. Further, vendor specific solutions are unsatisfactory as an industry solution. Accordingly, a need exists to provide a product or overlay system solution that operates with existing IEEE 802.11 network installations to enable fast handoffs between any vendors' IEEE 802.11 access points and minimize problems associated with latency.

Additional prior art solutions have been proposed but these solutions are also generally not satisfactory for fast handoffs to maintain uninterrupted voice communication. One known prior art for fast handoff in IEEE 802.11 networks proposed to utilize pre-authentication wherein the terminal device authenticates with the neighboring access points without associating with them. The pre-authentication signaling is exchanged over the radio via the current access point which current access point in turn relays the signaling to the neighboring access point or points. The pre-authentication prior art approach enables a slightly faster handoff because the keys derived in the pre-authentication can be used when moving to a neighboring access point however, the pre-authentication solution is unduly complex and requires more sophisticated access points.

Another known prior art solution for fast handoff proposes to utilize optimized association wherein Message Integrity Codes (MIC) are included in the first messages during association with an access point, that is, the context transfer or some other key distribution mechanism is used along the local LAN network to obtain keying material to the new access point. This prior art solution is less than satisfactory and implementation is complex.

A further known prior art solution for fast handoff proposes to utilize a “make-before-break” association wherein the terminal starts to associate and authenticate with the new access point while still being associated with the old access point. The association frames are extended to indicate that this is a “make-before-break” association so that the new access point does not invoke an inter-access point protocol (IAPP) at the time of indication. A further mechanism is added to this solution whereby the terminal indicates when it will actually move to the new access point and after this indication, the IAPP is invoked by the new access point in anticipation of the movement of the terminal device. Although this “make-before-break” association approach attempts to minimize interruptions during handoff, it is unduly complex and requires more sophisticated and complex terminal devices for implementation.

It is also known in the prior art that a single LAN radio can join several different LAN networks simultaneously to create an-hoc network and an infrastructure network. The techniques used in a single LAN radio joining several different LAN networks may be used to implement the “make-before-break” prior art association solution described above however this solution is not satisfactory because it requires new or additional features to be added to the Wireless Local Area Network for implementation.

The known prior art fast handoff methods and schemes generally require some change to the Wireless Local Area Network for implementation and therefore are not entirely satisfactory to provide a fast handoff in IEEE 802.11 networks. Accordingly, it is an object of the present invention to provide a fast handoff method for a communication session in Wireless Local Area Networks, particularly IEEE 802.11 networks that overcomes the disadvantages and shortcomings of the prior art.

### SUMMARY OF THE INVENTION

In accordance with the present invention, handoff of a communication session in a wireless network is presented in a wireless network interface including a terminal device having a first address (ADD1) and a second address (ADD2) wherein an ongoing communication session between the terminal device and an associated first access point (AP1) in the wireless network uses the first address (ADD1) and upon detecting the need for handover of the terminal device to a second access point (AP2) in the wireless network establishes a communication session between the terminal device and an associated second access point (AP2) using the second address (ADD2).

### BRIEF DESCRIPTION OF THE DRAWINGS

FIG. 1 is a schematic functional block diagram of a fast handoff system for a wireless local area network embodying the present invention;

FIG. 2 is a flowchart showing the major functional operations of the present invention for carrying out the fast handoff for a wireless local area network;

FIG. 3 is a schematic functional block diagram of a terminal device embodying the present invention having two Medium Access Control addresses for carrying out the fast handoff of a call in a wireless local area network.

### WRITTEN DESCRIPTION OF PREFERRED EMBODIMENTS

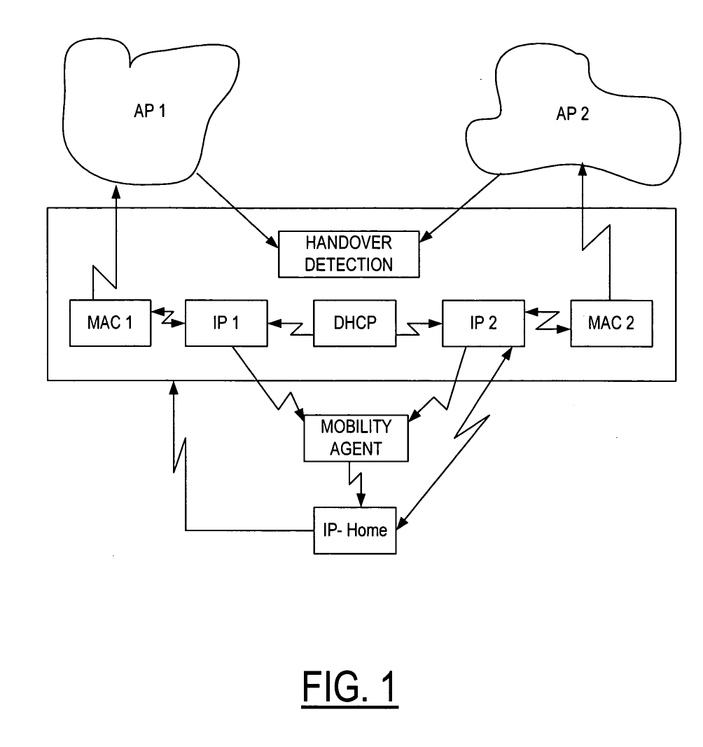

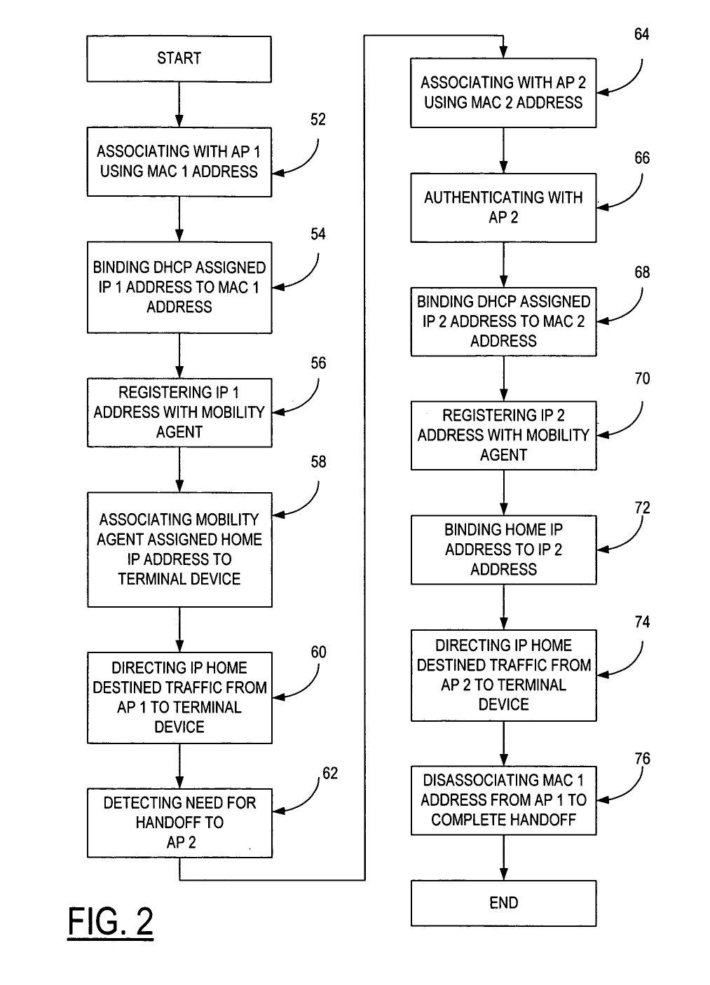

Turning now to the drawings and considering the invention in further detail with particular reference to FIGS. 1 and 2, a method for fast handoff of a communication session such as, for example, a call connection in a wireless local area network (WLAN) particularly IEEE 802.11 networks is illustrated. For purposes of explanation, a wireless network interface including a terminal device, such as for example a mobile terminal device or a mobile cellular telephone, generally designated 10 in FIG. 1 operates in a serving area having two access points, AP1 generally designated 12 and AP2 generally designated 14. As the terminal device 10 moves from the access point 12 (AP1) serving area to the access point 2 (AP2) serving area, traffic directed and intended for the mobile terminal 10 in a communication session must be transitioned or transferred from the access point 12 (AP10 to the access point 14 (AP2). The invention provides and enables the transfer or handoff of the call connection without degradation in the communication particularly, interruptions or breaks in the voice communication by ensuring that the traffic intended for the mobile terminal 10 is transmitted from access point 14 (AP2) prior to termination of the connection with access point 12 (AP1). The invention is implemented in “a make-before-break” framework wherein the association to the old WLAN access point is maintained until the new association with the new WLAN access point is established and authenticated.

In one embodiment, the invention is implemented with the terminal device 10 associating with the WLAN access point 12 (AP1) in step 52 using the first Medium Access Control (MAC1) address 16 (ADD1) of the mobile terminal 10. Next in step 54, a first internet protocol (IP1) address generally designated 18 is assigned using the Dynamic Host Configuration Protocol (DHCP) generally designated 20 and is bound to the MAC1 address 16 (ADD1). The first internet protocol (IP1) address 18 is registered with a mobility agent generally designated 22 in step 56. The mobility agent may be located at any location along the wireless local area network including within the mobile terminal 10 itself. The mobility agent 22 assigns a home internet protocol IP-home address generally designated 24 in step 58 to the terminal device 10 for purposes of identifying the terminal device 10 to receive IP home destined traffic transmitted from the access point 12 (AP1) as indicated in step 60. As the terminal device 10 moves into range of the access point 14 (AP2), a need for handoff from the access point 12 (AP1) to the access point 14 (AP2) is detected as indicated by the function block 26 in the terminal device 10 and as indicated in step 62. Once it is determined that a handover is required, the terminal device 10 begins to associate with the access point 14 (AP2) as indicated in step 64 using the second Medium Access Control (MAC2) address 28 (ADD2) of the terminal device 10 and begins authenticating with access point 14 (AP2) as indicated in step 66. In step 68, a second internet protocol (IP2) address 30 generated by the Dynamic Host Configuration Protocol (DHCP) 20 is bound to the (MAC2) address 28 (ADD2) and is registered with the mobility agent 22 in accordance with step 70. In step 72, the IP-home address 24 is bound to the (IP2) address 30. The terminal device 10 now has two active IEEE 802.11 associations and the terminal device 10 receives any IP-home destined traffic from the access point 14 (AP2) as indicated in step 74. Because the terminal device 10 is able to communicate using the IP-home address 24 via both the access point 12 (AP1) and the access point 14 (AP2) during the handover procedure, no interruption or further delay of IP-home destined traffic is incurred during the handover and thus many of the problems associated with latency are significantly reduced if not substantially eliminated. The mobile device 10 disassociates the (MAC1) address 16 (ADD1) from the access point 12 (AP1) to complete the handoff in step 76. The procedure is repeated as the terminal device 10 moves into another coverage area serviced by a different access point. Alternately, the first and second addresses ADD1 and ADD2 respectively, are implemented as link-layer addresses or as internet protocol (IP) addresses.

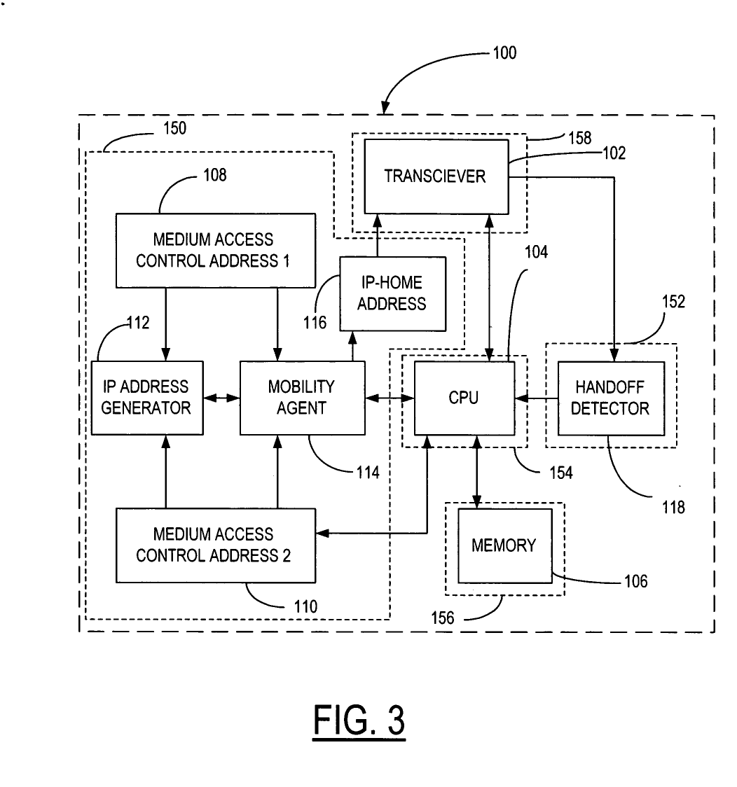

Turning now to FIG. 3, a schematic functional block diagram of a wireless network interface including a terminal device embodying the present invention is illustrated therein and generally designated 100. The terminal device 100 includes a transceiver 102 for sending and receiving signals to and from the wireless local area network (WLAN) in a well-known and understood manner. The terminal device 100 also includes a CPU or processor 104 for controlling the functional operations of the terminal device 100 in accordance with an instruction set stored in a memory 106 to carry out the desired intended functions and operations of the terminal device. In accordance with one embodiment of the present invention, the terminal device 100 includes two Medium Access Control Addresses 108 (ADD1) and 110 (ADD2) respectively for use in establishing simultaneous active IEEE 802.11 associations with two different access points to carry out the handoff of the communication session connection from one access point to the other access point. The terminal device 100 includes an Internet Protocol (IP) address generator 112 for generating IP addresses in accordance with the Dynamic Host Configuration Protocol (DHCP) for binding with the Medium Access Control Addresses 108 (ADD1), 110 (ADD2) respectively. A mobility agent 114 registers the Medium Access Control Addresses 108 (ADD1) and 110 (ADD2) and assigns an IP-home address 116 to identify the terminal device 100 so that it can receive IP-home directed traffic from the serving access points.

It is contemplated that the invention may also be implemented in a suitable hardware component configuration including but not limited to, a chip, chipset, integrated circuitry, discrete component circuitry, as an extension circuit board, an expansion circuit board, an add-on device such as an accessory card or as an attachment device to an existing device, for example, another hardware electronic device such as a PDA, mobile computer or other mobile devices well known and understood in the art. Referring to FIG. 3, a part or all of terminal 100 could be implemented as a chip set wherein for purposes of illustration and example, the functions of the Medium Access Control Addresses 108 (ADD1) and 110 (ADD2), the Internet Protocol (IP) address generator 112, the mobility agent 114 and IP-home address 116 can be carried out in an integrated circuit chip 150. The handoff detector 118 can be implemented in an integrated circuit chip 152. The CPU 104 can be implemented in a chip 154. The memory 106 can be implemented in a chip 156. Even the transceiver 102 can be implemented in a chip 158. The hardware component implementation may be accomplished using any suitable technology or combination of different technologies well known to those skilled in the art to carry out the intended functions as set forth for example in the flowchart shown in FIG. 2 and described above.

In a further embodiment, the terminal device is suitably configured and arranged to emulate two separate wireless network interfaces with the first of the two emulated wireless network interfaces having the first address (ADD1) and the second of the two wireless network interfaces having the second address (ADD2).

A computer program which may be carried on a storage medium or stored within the memory 106 and which is executable by the CPU 104 in the terminal device 100 may be used to control the handing off of a communication session connection in an IEEE 802.11 network in accordance with the method of the present invention as described above.

The invention also contemplates a software application product for handing off a communication session in a wireless network and includes suitable program code for providing a wireless network interface including a terminal device having a first address (ADD1) and a second address (ADD2) wherein an ongoing communication session between the terminal device and an associated first access point (AP1) in the wireless network uses the first address (ADD1); for detecting the need for handover of the terminal device to a second access point (AP2) in the wireless network, and for establishing a communication session between the terminal device and an associated second access point (AP2) using the second address (ADD2).

The terminal device 100 also includes handoff detection functionality as indicated by the function block 118 to sense and detect in a well known manner the need to handoff the communication session connection from one access point to another access point.

A method, terminal device and system for fast handoff of a communication session connection in an IEEE 802.11 network has been described above in several preferred embodiments. It will be understood that numerous changes and modifications may be made by those skilled in the art to the embodiments described above and therefore the invention has been explained by way of illustration rather than limitation.

The invention claimed is:

1. Method, comprising the steps of:
handing off a communication session in a wireless network, further comprising the steps of:
providing a wireless network interface including a terminal device having a first address (ADD1) and a second address (ADD2);
having an ongoing communication session between the terminal device and an associated first access point (AP1) in the wireless network using the first address (ADD1);
detecting the need for handover of the terminal device to a second access point (AP2) in the wireless network;
establishing a communication session between the terminal device and an associated second access point (AP2) using the second address (ADD2).

2. The method as defined in claim 1 wherein the steps of using the first address (ADD1) and the second address (ADD2) further comprise using link-layer addresses.

3. The method as defined in claim 1 wherein the steps of using the first address (ADD1) and the second address (ADD2) further comprise using Medium Access Control (MAC) addresses.

4. The method as defined in claim 1 wherein the steps of using the first address (ADD1) and the second address (ADD2) further comprise using Internet Protocol (IP) addresses.

5. The method as defined in claim 4 further comprising the steps of:
associating the first address (ADD1) with a first IP (IP1) address, and
associating the second address (ADD2) with a second IP (IP2) address.

6. The method as defined in claim 5 further comprising the steps of dynamically configuring the first IP address (IP1) and the second IP address (IP2).

7. The method as defined in claim 5 further comprising the step of providing a home IP address (IP-home) to the terminal device.

8. The method as defined in claim 7 further comprising the steps of:
binding at least one of the first address (ADD1) or first IP address (IP1) with the home IP address (IP-home) when the terminal device is associated with the first access point (AP1), and
binding at least one of the second address (ADD2) or second IP address (IP2) with the home IP address (IP-home) when the terminal device is associated with the second access point (AP2).

9. The method as defined in claim 2 further comprising the step of providing a home IP address (IP-home) to the terminal device via a mobility agent.

10. The method as defined in claim 2 further comprising the step of providing a home IP address (IP-home) to the terminal device via a virtual private network (VPN) gateway.

11. The method as defined in claim 1 wherein said wireless network interface emulates two separate wireless network interfaces further comprising the steps of the first of the two separate wireless network interfaces using the first address (ADD1) and the second of the two separate wireless network interfaces using the second address (ADD2).

12. A terminal device, comprising:
a first address (ADD1);
a second address (ADD2);
a transceiver suitably arranged for operation in a wireless network to provide an ongoing communication session between said terminal device and an associated first access point (AP1) in the wireless network using said first address (ADD1) and to provide an ongoing communication session between said terminal device and an associated second access point (AP2) in the wireless network using said second address (ADD2) upon detection of the need for handover from the first access point (AP1) to the second access point (AP2).

13. The terminal device as defined in claim 12 wherein said first and second addresses (ADD1) and (ADD2) are link-layer addresses.

14. The terminal device as defined in claim 12 wherein said first and second addresses (ADD1) and (ADD2) are Multiple Access Control (MAC) addresses.

15. The terminal device as defined in claim 12 wherein said first and second addresses (ADD1) and (ADD2) are Internet Protocol (IP) addresses.

16. The terminal device as defined in claim 12 further comprising a mobile terminal device.

17. The terminal device as defined in claim 12 further comprising a mobile cellular telephone.

18. The terminal device as defined in claim 12 further comprising a single wireless network interface emulating two separate wireless network interfaces, the first of said two emulated wireless network interfaces having said first address (ADD1) and the second of said two emulated wireless network interfaces having said second address (ADD2).

19. A software application product, comprising a storage medium having a software application for handing off a communication session in a wireless network, said software application comprising:
program code for providing a wireless network interface including a terminal device having a first address (ADD1) and a second address (ADD2) wherein in an ongoing communication session between the terminal device and an associated first access point (AP1) in the wireless network uses the first address (ADD1);
program code for detecting the need for handover of the terminal device to a second access point (AP2) in the wireless network; and
program code for establishing a communication session between the terminal device and an associated second access point (AP2) using the second address (ADD2).

20. A hardware component for handing off a communication session in a wireless network, said hardware component comprising:
means for associating a network interface including a terminal device with a first access point (AP1) using a first address (ADD1);
means for binding a DHCP assigned first internet protocol address (IP1) to said first address (ADD1);
means for registering said first internet protocol address (IP1) with a mobility agent;
means for associating a mobility agent assigned home IP address (IP-home) to the terminal device;
means for directing IP-home destined traffic from said first access point (AP1) to the terminal device;
means for detecting the need to handoff the communication session to a second access point (AP2);
means for associating the network interface with said second access point (AP2) using a second address (ADD2);
means for authenticating the terminal device with said second access point (AP2);
means for binding a DHCP assigned second internet protocol address (IP2) to said second address (ADD2);
means for registering said second internet protocol address (IP2) with said mobility agent;
means for binding said IP-home address to said second internet protocol address (IP2);
means for directing IP-home destined traffic from said second access point (AP2) to the terminal device, and
means for disassociating said first address (ADD1) from said first access point (AP1) to complete the communication session handoff.
